(19) United States
(12) Patent Application Publication
(10) Pub. No.: US 2025/0266726 A1
(43) Pub. Date: Aug. 21, 2025

(54) ROTATING ELECTRIC MACHINE SYSTEM

(71) Applicant: HONDA MOTOR CO., LTD., Tokyo (JP)

(72) Inventors: Tsubasa Nakatomi, Wako-shi (JP); Tatsuya Choji, Wako-shi (JP)

(21) Appl. No.: 19/022,326

(22) Filed: Jan. 15, 2025

(30) Foreign Application Priority Data
Feb. 21, 2024 (JP) 2024-024670

(51) Int. Cl. H02K 1/32; H02K 5/20

(52) U.S. Cl. CPC H02K 1/32; H02K 5/203

(57) ABSTRACT

A rotor of a rotating electric machine system includes a sleeve and a collar. An internal space is formed between a rotating shaft and the collar. In the sleeve, in an inserted portion that is inserted into the internal space, a communication flow path is formed that serves to place the rotor internal flow path and the internal space in communication. An outer circumferential surface of the inserted portion includes an abutment surface against which an inner circumferential surface of the collar abuts. The sleeve includes an inlet port from the internal flow path to the communication flow path, and an outlet port from the communication flow path to the internal space.

### CROSS-REFERENCE TO RELATED APPLICATIONS

This application is based upon and claims the benefit of priority from Japanese Patent Application No. 2024-024670 filed on Feb. 21, 2024, the contents of which are incorporated herein by reference.

### BACKGROUND OF THE INVENTION

### Field of the Invention

The present invention relates to a rotating electric machine system equipped with a rotating electric machine having a rotor and a stator, and a housing in which the stator is accommodated.

### Description of the Related Art

The rotating electric machine includes a rotor having a rotating shaft, and a stator positioned on the outer circumference of the rotor. The rotor includes permanent magnets that are retained on the rotating shaft. When the rotating shaft rotates, an induced electric current is generated in an electromagnetic coil that makes up the stator. In this case, the rotating electric machine functions as a generator.

When the induced electric current occurs continuously in the electromagnetic coil, the electromagnetic coil becomes high in temperature. Accordingly, the permanent magnets take on radiant heat. Further, when the rotating shaft is caused to rotate at a high speed, the rotor is subjected to a large amount of air resistance. As can be appreciated from the reasons mentioned above, the temperature of the permanent magnets becomes high. As the temperature of the permanent magnets approaches the Curie temperature, the magnetic force of the permanent magnets decreases.

In JP 2011-097784 A, there is proposed a configuration in which a coolant supply passage is formed in a hollow interior of a rotating shaft, and further, a coolant flow through space is formed between the rotating shaft and a rotor core. The rotor core is positioned and fixed to the rotating shaft via two individual retainers. Moreover, in the rotating shaft, a communication passage is formed in a diametrical direction thereof. Further, in each of the two individual retainers, there is provided a coolant discharge outlet port.

A cooling liquid is supplied to the coolant supply passage. The cooling liquid, next, travels via the communication passage to the outer circumferential surface of the rotating shaft, and thereafter, flows through the coolant flow through space. The cooling liquid is discharged via the coolant discharge outlet port to the exterior of the rotor (into a hollow interior of the housing). The cooling liquid flows towards the stator. Moreover, In JP 2011-097784 A, cooling oil is cited as an example of the cooling liquid.

### SUMMARY OF THE INVENTION

It is undesirable for the cooling liquid to leak out to any location other than the normal discharge outlet port.

The present invention has the object of solving the aforementioned problem.

An aspect of the invention is characterized by a rotating electric machine system including a rotating electric machine including a rotor and a stator, and a housing in which the stator is accommodated.

The rotor includes a rotating shaft, a sleeve configured to cover the rotating shaft from an outer circumferential side, permanent magnets configured to be retained in the sleeve, a collar configured to be disposed on the outer circumferential side relative to the sleeve and the rotating shaft, a rotor internal flow path configured to include an annular shaped space formed between an outer circumferential surface of the rotating shaft and an inner circumferential surface of the sleeve, and configured to extend in an axial direction of the rotating shaft, and an internal space formed between the outer circumferential surface of the rotating shaft and an inner circumferential surface of the collar. The rotating electric machine system includes a liquid coolant supplying device configured to supply a liquid coolant to the rotor internal flow path. The sleeve includes an inserted portion that is an axial end portion of the sleeve and is inserted into the internal space to separate the internal space from the rotor internal flow path, and a communication flow path that is formed in the inserted portion and is configured to place the internal space and the rotor internal flow path in communication. The outer circumferential surface of the inserted portion includes an abutment surface against which the inner circumferential surface of the collar abuts.

In the above-described configuration, an inlet port through which the liquid coolant flows in from the rotor internal flow path into the communication flow path, and an outlet port through which the liquid coolant flows out from the communication flow path into the internal space are located more inwardly in a diametrical direction of the rotating shaft than the abutment surface.

According to the present invention, it is possible to prevent the liquid coolant from leaking out from between the abutment surface, which is one portion of the outer circumferential surface of the sleeve, and the inner circumferential surface in the collar that is placed in abutment against the abutment surface.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic overall perspective view of a combined power system including a rotating electric machine system according to an embodiment of the present invention;

FIG. 2 is a schematic cross-sectional side view of the rotating electric machine system as viewed from a direction perpendicular to an axial direction;

FIG. 3 is a schematic cross-sectional side view of the rotating electric machine system as viewed from a direction perpendicular to the axial direction, at an angle of rotation that is different from that shown in FIG. 2;

FIG. 4 is an enlarged cross-sectional view of main parts in the vicinity of a first bearing;

FIG. 5 is an enlarged cross-sectional view of main parts in the vicinity of a second bearing;

FIG. 6 is a schematic perspective view of one end part (a second end) in the axial direction of a sleeve; and

FIG. 7 is a schematic flow diagram showing flow through passages of a gaseous coolant and a liquid coolant.

### DETAILED DESCRIPTION OF THE INVENTION

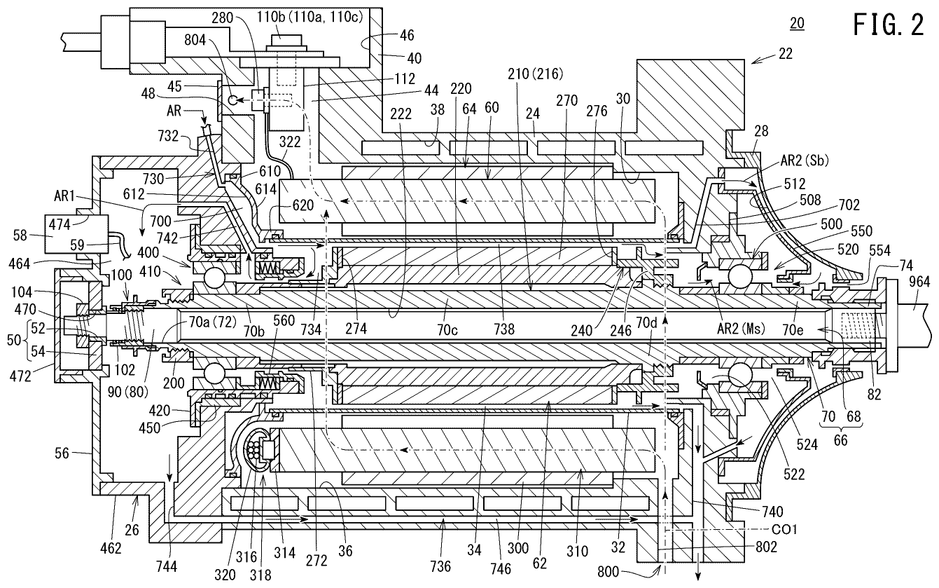

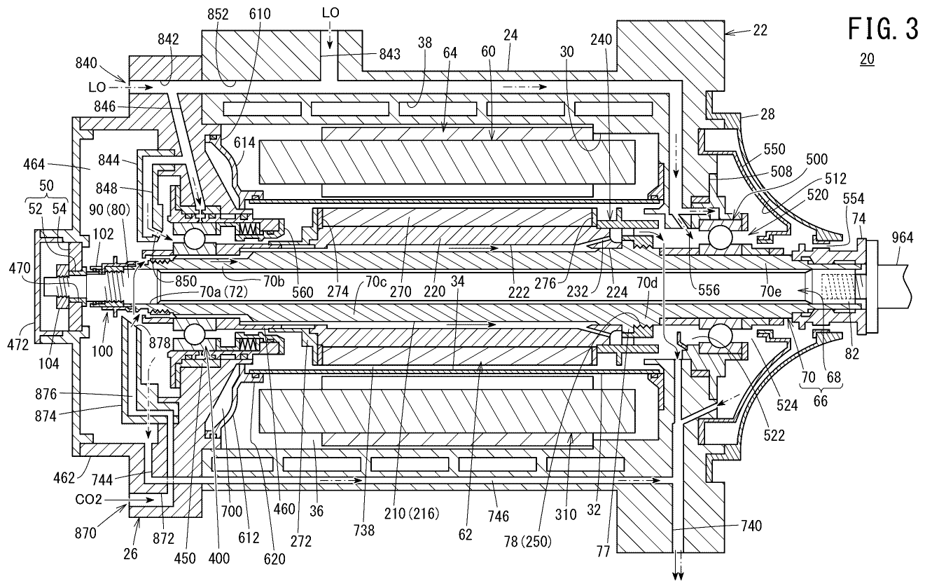

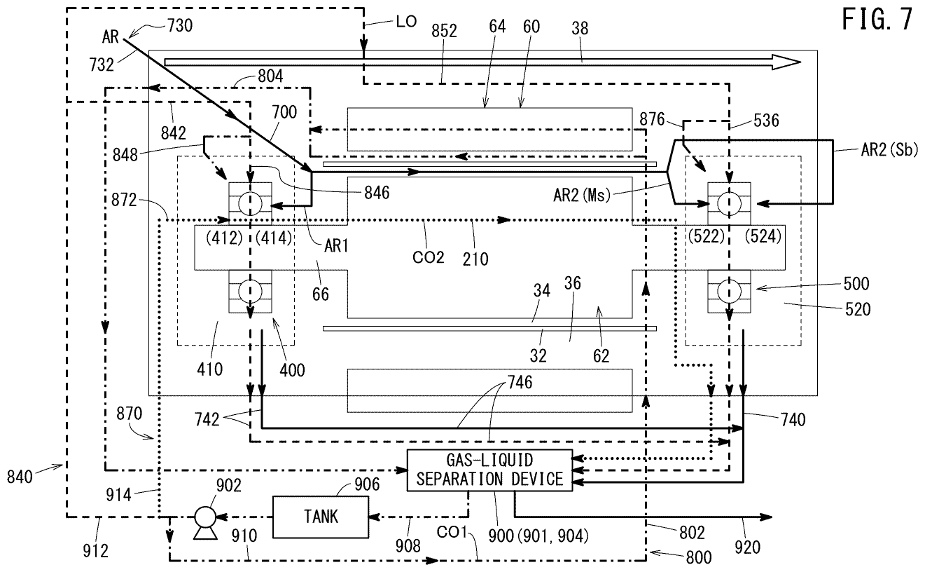

In the following description, compressed air AR (refer to FIG. 2 and FIG. 7) is illustrated as an example of a gaseous coolant, and a cooling oil CO1 and a cooling oil CO2 (refer to FIG. 2, FIG. 3, and FIG. 7) are illustrated as examples of a liquid coolant. In the present embodiment, the cooling oil CO1 and the cooling oil CO2 are supplied from a same oil supplying device 904 (refer to FIG. 7) as a lubricating oil LO that is supplied to a first bearing 400 and a second bearing 500. However, these are merely exemplary illustrations. The gaseous coolant may be compressed nitrogen or the like. The liquid coolant may be an oil supplied from an oil supplying device that is separate from the oil supplying device 904. The liquid coolant may be an organic solvent with a high boiling point and a low volatility.

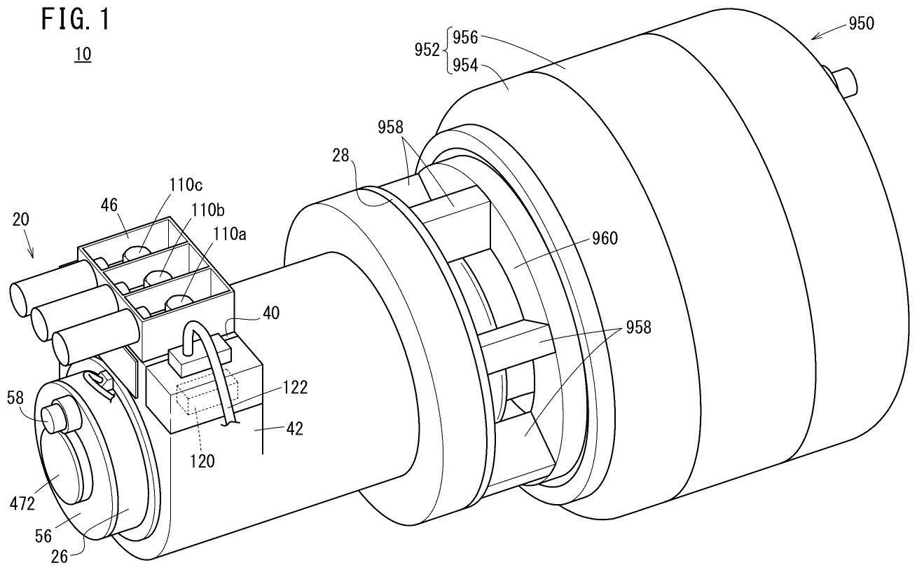

FIG. 1 is a schematic overall perspective view of a combined power system 10 according to the present embodiment. The combined power system 10 is equipped with a rotating electric machine system 20 according to the present embodiment, and a gas turbine engine 950. An axial line of the rotating electric machine system 20 and an axial line of the gas turbine engine 950 coincide with each other. Stated otherwise, the rotating electric machine system 20 and the gas turbine engine 950 are arranged in series on the same axial line.

The combined power system 10 is used, for example, as a motive power source for providing propulsion in a flying object, a ship, an automobile, or the like. Suitable specific examples of the flying object include drones and multi-copters. The combined power system 10, when mounted on a flying object, is used as a power drive source for rotationally driving, for example, a prop, a ducted fan, or the like. The combined power system 10, when mounted on a ship, is used as a screw rotational force generating device. The combined power system 10, when mounted on an automobile, is used as a power drive source for rotating a motor.

The combined power system 10 can also be used as an auxiliary electrical power source in an aircraft, a ship, a building, or the like. Apart therefrom, it is also possible to utilize the combined power system 10 as gas turbine power generation equipment.

The gas turbine engine 950 is an internal combustion engine. Further, the gas turbine engine 950 serves as a gaseous coolant supplying device that supplies compressed air AR. As will be discussed later, the compressed air AR circulates as a gaseous coolant inside a rotating electric machine housing 22.

In the following description, the respective terms “left”, “right”, “lower”, and “upper” refer specifically to the left, right, lower, and upper directions shown in FIG. 2 and FIG. 3. However, these directions are provided for the sake of convenience in order to simplify the description and facilitate understanding. In particular, the directions described in the specification are not limited to the directions when the combined power system 10 is actually used.

Further, in the following description, the left end in the axial direction of each of the rotating electric machine system 20 and the gas turbine engine 950 may be referred to as a first end. Similarly, the right end in the axial direction of each of the rotating electric machine system 20 and the gas turbine engine 950 may be referred to as a second end. Further, in each of the members, a surface facing toward the first end may be referred to as a “first end surface”, and a surface facing toward the second end may be referred to as a “second end surface”.

A description will be given concerning the rotating electric machine system 20. FIG. 2 and FIG. 3 are schematic cross-sectional side views of the rotating electric machine system 20 as viewed from a direction perpendicular to the axial direction. Moreover, in FIG. 2 and FIG. 3, the angles of rotation of the rotating electric machine system 20 are mutually different from each other. The rotating electric machine system 20 is equipped with a rotating electric machine 60, and the rotating electric machine housing 22 (a housing) in which the rotating electric machine 60 is accommodated. In the present embodiment, the rotating electric machine 60 is a generator.

The rotating electric machine housing 22 includes a main housing 24, a first sub-housing 26, and a second sub-housing 28. A first end and a second end of the main housing 24 are open ends, and the main housing 24 exhibits a substantially cylindrical shape. The first sub-housing 26 is connected to the first end (the left open end) of the main housing 24. The second sub-housing 28 is connected to the second end (the right open end) of the main housing 24. In the manner described above, the first end and the second end of the main housing 24 are closed.

As shown in FIG. 1, a first casing 40 and a second casing 42 are provided on the outer circumferential surface of the main housing 24. A description will be given later concerning the first casing 40 and the second casing 42.

A cooling jacket 38 is formed in the interior of a side circumferential part of the main housing 24. A cooling medium such as cooling water or the like flows through the cooling jacket 38.

As shown in FIG. 2 and FIG. 3, the main housing 24 includes a hollow interior portion 30. The hollow interior portion 30 is divided by a partition wall member 32 into a rotor chamber 34 and a stator chamber 36. The rotor chamber 34 is a chamber that is formed on an inner side (an inner circumferential side) in a diametrical direction of the partition wall member 32. The stator chamber 36 is a chamber that is formed on an outer side (an outer circumferential side) in the diametrical direction of the partition wall member 32.

The rotating electric machine 60 is equipped with a rotor 62, and a stator 64 that surrounds an outer circumference of the rotor 62. The partition wall member 32 is interposed between the rotor 62 and the stator 64 in a diametrical direction of a rotating shaft 66. Accordingly, the rotor 62 is positioned on the inner circumferential side of the partition wall member 32. Stated otherwise, the rotor 62 is accommodated in the rotor chamber 34. The stator 64 is positioned on the outer circumferential side of the partition wall member 32. Stated otherwise, the stator 64 is accommodated in the stator chamber 36.

The partition wall member 32, for example, is a cylindrically shaped body made up from an insulating and a non-magnetic ceramic. It is preferable that a separation distance between the outer circumferential surface of permanent magnets 270 constituting the rotor 62, and the inner circumferential surface of the partition wall member 32 be greater than a separation distance between the outer circumferential surface of the partition wall member 32 and a plurality of individual electromagnetic coils 310 constituting the stator 64. The value of the former is preferably set to be approximately 2.5 times to approximately 4 times the value of the latter. To cite one example of a combination of the former and the latter, the value of the former lies within a range of from 1.1 mm to 2.1 mm, and the value of the latter lies within a range of from 0.3 mm to 0.5 mm.

A first end of the partition wall member 32 is inserted into the interior of a tubular shaped portion 620 that projects out in the axial direction from a first wall surface 612 of a partition member 610. The inner surface of the stator chamber 36 includes the first wall surface 612 of the partition member 610, the outer circumferential surface of the partition wall member 32, and the inner circumferential surface of the main housing 24. More specifically, the first wall surface 612 of the partition member 610 forms one portion of the inner surface of the stator chamber 36. By the partition wall member 32, the partition member 610, and the inner circumferential surface of the main housing 24, the rotor chamber 34 and the stator chamber 36 are separated in a liquid-tight and airtight manner. More specifically, the rotor chamber 34 and the stator chamber 36 are spaces that are independent from each other.

The rotor 62 is constituted by including the rotating shaft 66, a sleeve 220, and the permanent magnets 270. An inner hole 222, which extends in the axial direction of the sleeve 220, is formed in the sleeve 220. The rotating shaft 66 passes through the inner hole 222. Accordingly, in the diametrical direction of the rotating shaft 66, the sleeve 220 is interposed between the rotating shaft 66 and the permanent magnets 270. A major portion of a later-described rotor internal flow path 210 is formed by the inner hole 222 and the rotating shaft 66.

The rotating shaft 66 includes an inner shaft 68, and a hollow tubular shaped outer shaft 70. Both ends of the outer shaft 70 are open ends. More specifically, as shown in FIG. 2, the outer shaft 70 has a first hollow end part 72 and a second hollow end part 74.

The inner shaft 68 is removably inserted into the interior of the outer shaft 70. The inner shaft 68 is longer in length than the outer shaft 70. As shown in FIG. 2, the inner shaft 68 includes a left end part 80 (an end part on a first end side) which is one end part in the axial direction, and a right end part 82 (an end part on a second end side) which is another end part in the axial direction.

One portion of the left end part 80 is exposed from the first hollow end part 72 of the outer shaft 70. Hereinafter, in the left end part 80, one portion thereof that is exposed from the first hollow end part 72 will be referred to as an extending portion 90. The extending portion 90 is connected to the first hollow end part 72 of the outer shaft 70 by a positioning fixture 100 that includes a nut member 102 or the like.

A resolver rotor 52 and a lock nut 104 are provided on an extending distal end of the extending portion 90. By the lock nut 104, the resolver rotor 52 is prevented from coming off from the extending portion 90.

A first end of an output shaft 964 that constitutes the gas turbine engine 950 is connected to the right end part 82 of the inner shaft 68. A description will be given later concerning this feature.

The outer shaft 70 includes a first shaft portion 70a to a fifth shaft portion 70e in a direction from the first end to the second end. The outer diameter becomes larger in a stepwise manner from the first shaft portion 70a until the fourth shaft portion 70d. The outer diameter of the fifth shaft portion 70e is smaller than the outer diameter of the fourth shaft portion 70d, and further, is substantially the same as the outer diameter of the third shaft portion 70c.

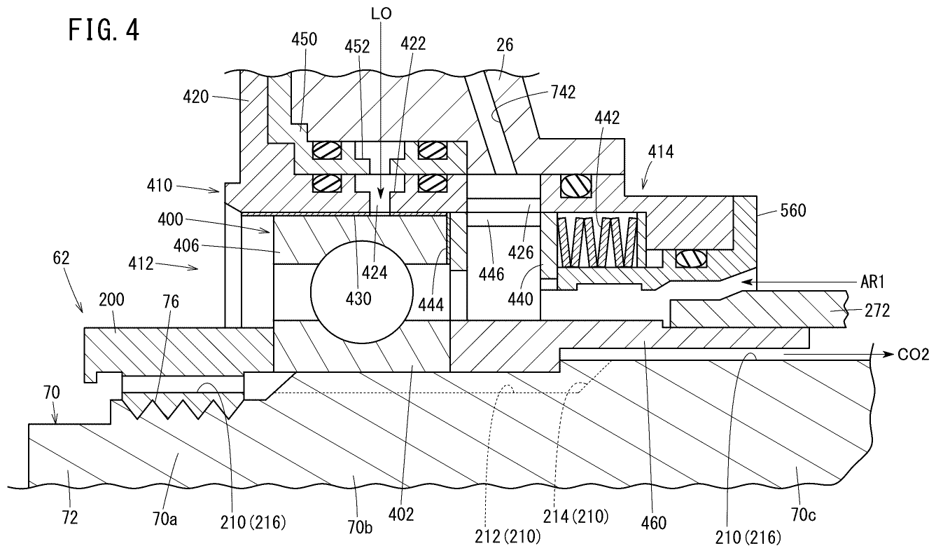

As shown in FIG. 4, the first shaft portion 70a has a first external thread 76 thereon. As shown in FIG. 3 and FIG. 4, a second shaft portion 70b has a plurality of individual groove shaped flow paths 212 formed on an outer circumferential surface thereof in the circumferential direction of the second shaft portion 70b. In FIG. 4, an individual one from among the plurality of individual groove shaped flow paths 212 is shown. Each of the plurality of individual groove shaped flow paths 212 is recessed inwardly in a diametrical direction of the rotating shaft 66 from the outer circumferential surface of the second shaft portion 70b, and extends in the axial direction of the rotating shaft 66.

The third shaft portion 70c has a cylindrical shape in which an inner diameter and an outer diameter thereof are substantially constant. A plurality of individual guide flow paths 214 are formed on the outer circumferential surface of the third shaft portion 70c in the circumferential direction of the third shaft portion 70c. In FIG. 4, an individual one from among the plurality of individual guide flow paths 214 is shown. Each of the plurality of guide flow paths 214 is formed at a first end of the third shaft portion 70c facing toward the second shaft portion 70b. First ends of the guide flow paths 214 are connected to second ends of the groove shaped flow paths 212. The guide flow paths 214 constitute one portion (to be discussed later) of the rotor internal flow path 210. The guide flow paths 214, as they separate away from the second shaft portion 70b, are inclined in a manner so as to be inclined from the inner side toward the outer side (the outer circumferential surface of the third shaft portion 70c) in the diametrical direction of the rotating shaft 66.

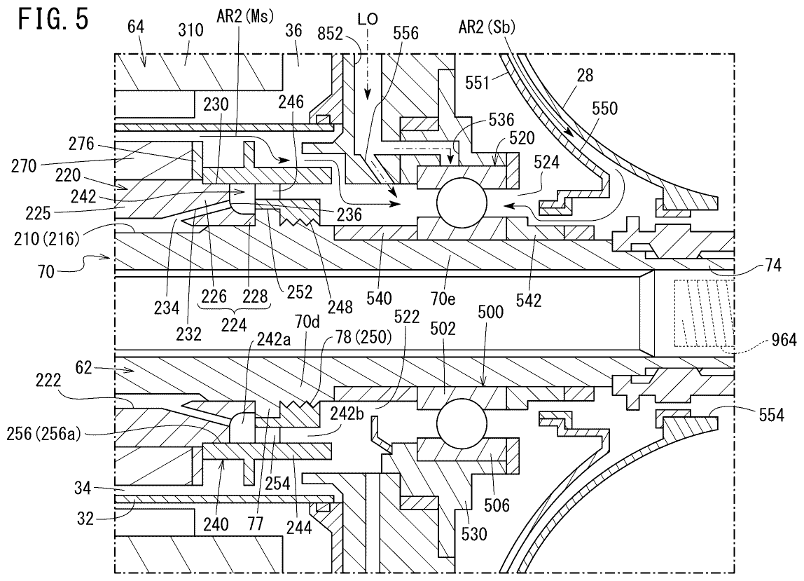

As shown in FIG. 2 and FIG. 5, the fourth shaft portion 70d includes on the outer circumferential surface thereof a flange member 77 and a second external thread 78. As shown in FIG. 2, FIG. 3, and FIG. 5, the fifth shaft portion 70e is of a cylindrical shape in which the inner diameter and the outer diameter thereof are substantially constant.

As shown in FIG. 2, FIG. 3, and FIG. 4, a screw cap 200 is screwed onto the first external thread 76 of the first shaft portion 70a. A second end surface of the screw cap 200 abuts against a first end surface of a first inner ring 402 (refer to FIG. 4) of the first bearing 400.

As shown in FIG. 2 and FIG. 3, most of the third shaft portion 70c is covered with the sleeve 220. Stated otherwise, the sleeve 220 covers from an outer circumferential side the third shaft portion 70c that constitutes the rotating shaft 66.

The permanent magnets 270 are retained in the sleeve 220. In the present aspect, the rotor 62 is a so-called SPM (surface permanent magnet motor) type in which the permanent magnets 270 are disposed on the outer circumferential surface of the sleeve 220. Alternatively, the rotor 62 may be of a so-called IPM (interior permanent magnet motor) type in which the permanent magnets 270 are embedded in the sleeve 220.

The sleeve 220 and the permanent magnets 270 are sandwiched between a magnet stopper 272 and a collar 240 in the axial direction of the rotating shaft 66. In accordance therewith, the sleeve 220 is positioned and fixed on an outer circumferential surface of the outer shaft 70. More specifically, a positional deviation of the sleeve 220 and the permanent magnets 270 with respect to the outer shaft 70 is prevented. In this manner, by fixing and positioning the sleeve 220, the magnet stopper 272 and the collar 240 serve to position and fix the permanent magnets 270.

As shown in FIG. 4, one portion of the magnet stopper 272 is interposed between an inner circumferential surface of a guide member 560 and an outer circumferential surface of an inner ring stopper 460. A first ring body 274 is sandwiched between the magnet stopper 272 and the permanent magnets 270 in the axial direction of the rotating shaft 66. A second ring body 276 is sandwiched between the permanent magnets 270 and the collar 240 in the axial direction of the rotating shaft 66.

The collar 240 is disposed on an outer circumferential side of the sleeve 220 and the fourth shaft portion 70d. An internal space 242 is formed between the outer circumferential surface of the fourth shaft portion 70d and an inner circumferential surface 256 of the collar 240. More specifically, the rotor 62 includes the internal space 242. As shown in FIG. 5, an inserted portion 224 of the sleeve 220 is inserted into the internal space 242. The inserted portion 224 is an end portion at a second end of the sleeve 220.

In an exemplary illustration, the inserted portion 224 includes a first annular shaped convex portion 226, and a second annular shaped convex portion 228. In the sleeve 220, the first annular shaped convex portion 226 is a portion that is projected out in an annular shape in the axial direction from the second end of a main body portion 225, the inner diameter and the outer diameter of which are constant. The first annular shaped convex portion 226 is smaller in diameter than the main body portion 225. The second annular shaped convex portion 228 is a portion that is projected out in an annular shape in the axial direction of the sleeve 220 from the second end of the first annular shaped convex portion 226. The second annular shaped convex portion 228 is smaller in diameter than the first annular shaped convex portion 226.

The inserted portion 224 may be at the second end of the main body portion 225. More specifically, it is not essential that the inserted portion 224 includes the first annular shaped convex portion 226 and the second annular shaped convex portion 228.

The outer circumferential surface of the first annular shaped convex portion 226 abuts against an inner circumferential surface 256a of a first inner chamber 242a. The inner circumferential surface 256a of the first inner chamber 242a is one portion of the inner circumferential surface 256 of the collar 240. Hereinafter, in the outer circumferential surface of the first annular shaped convex portion 226, a portion thereof that abuts against the inner circumferential surface 256a of the collar 240 will be referred to as an abutment surface 230. In the illustrated example, the entirety of the outer circumferential surface of the first annular shaped convex portion 226 is the abutment surface 230. However, the abutment surface 230 may be one portion of the outer circumferential surface of the first annular shaped convex portion 226.

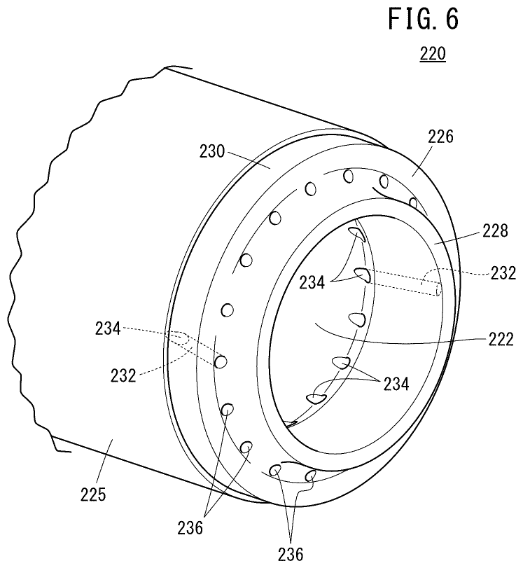

The second annular shaped convex portion 228 constituting the inserted portion 224 separates the rotor internal flow path 210, and the internal space 242. As shown in FIG. 5 and FIG. 6, a communication flow path 232 is provided, which extends from the inner circumferential surface of the main body portion 225 to the first end of the second annular shaped convex portion 228. The communication flow path 232 may be one individual flow path, or may be a plurality of individual flow paths.

The rotor internal flow path 210 and the internal space 242 communicate with each other via the communication flow path 232. An inlet port 234 for the cooling oil CO2 to the communication flow path 232 is formed on the inner circumferential surface of the main body portion 225 in facing relation to the rotor internal flow path 210. An outlet port 236 for the cooling oil CO2 from the communication flow path 232 is formed at a first end of the second annular shaped convex portion 228 in facing relation to the internal space 242. The inlet port 234 is positioned more inwardly in the diametrical direction of the rotating shaft 66 than the outlet port 236. The outlet port 236 is positioned more inwardly in the diametrical direction of the rotating shaft 66 than the abutment surface 230. Therefore, the outlet port 236 is not formed in the abutment surface 230. Accordingly, the entirety of the abutment surface 230 abuts against the inner circumferential surface 256a of the first inner chamber 242a.

The communication flow path 232, as it approaches in close proximity to the internal space 242 from the rotor internal flow path 210, or stated otherwise, as it approaches from the inlet port toward the outlet port, is inclined in a manner so as to face from an inner side to an outer side in the diametrical direction of the rotating shaft 66. However, this feature is just one aspect. The communication flow path 232 may be an L-shaped member having a portion that extends in the axial direction.

The collar 240 includes a tubular shaped portion 244 and a partition wall 246. The partition wall 246 is formed in a disk-like shape in the interior of the tubular shaped portion 244. An insertion hole 248 through which the rotating shaft 66 is inserted is formed at the center in the diametrical direction of the partition wall 246. An internal thread 250 is formed on the inner circumferential surface of the insertion hole 248. Further, a receiving hole 252 is connected to a first end side of the insertion hole 248. The inner diameter of the receiving hole 252 is larger than the inner diameter of the insertion hole 248. The flange member 77, which is provided on the fourth shaft portion 70d in the outer shaft 70, engages with the receiving hole 252. The internal thread 250 is screw-engaged with the second external thread 78 that is provided on the fourth shaft portion 70d. In the manner described above, the collar 240 is retained on the outer shaft 70.

The partition wall 246 divides the internal space 242 into the first inner chamber 242a and a second inner chamber 242b. In the diametrical direction of the partition wall 246, a discharge flow path 254 is formed more on the outer circumference than the insertion hole 248. The discharge flow path 254 may be one individual flow path, or may be a plurality of individual flow paths. The first inner chamber 242a and the second inner chamber 242b are placed in communication by the discharge flow path 254. The inner circumferential surface 256a of the first inner chamber 242a abuts against the abutment surface 230 of the sleeve 220.

Next, a description will be given concerning the configuration around the circumference of the first end of the rotor 62.

As shown in FIG. 2, FIG. 3, and FIG. 4, the second shaft portion 70b of the outer shaft 70 is retained via the first bearing 400 to be capable of rotating in the first sub-housing 26. Specifically, a first bearing chamber 410 is formed in the first sub-housing 26. A hollow tubular shaped first bearing holder 420, and a hollow tubular shaped holder spacer 450 are inserted into the first end side of the first bearing chamber 410. The first bearing 400 is interposed between the second shaft portion 70b and the first bearing holder 420. The first end of the rotating shaft 66 is passed through the first inner ring 402 of the first bearing 400.

An insulating material 430 is interposed between the outer surface of a first outer ring 406 of the first bearing 400, and the inner surface of the first bearing holder 420. Due to the insulating material 430, the first bearing 400 and the first bearing holder 420 are electrically insulated.

As shown in FIG. 4, an annular shaped groove 422 is formed in the first bearing holder 420. Within the annular shaped groove 422, a plurality of first oil supply holes 424 are radially formed. Further, in the holder spacer 450, a plurality of individual communication holes 452 are formed in a radial shape. An inner circumferential opening of each of the plurality of individual communication holes 452 overlaps with the outer circumferential opening of each of the plurality of individual first oil supply holes 424. The plurality of individual communication holes 452 and the plurality of individual first oil supply holes 424 are holes for the purpose of supplying the lubricating oil LO from the oil supplying device 904 to the first bearing 400.

The first bearing holder 420 includes a plurality of individual flow through holes 426 therein. The plurality of individual flow through holes 426 are holes for the purpose of discharging the lubricating oil LO that was supplied to the first bearing 400 to the exterior of the first bearing holder 420.

A spacer ring 440 is positioned and fixed inside an interior of the first bearing holder 420. A pressure applying member 442 made up from a disk spring applies a load (an applied pressure), via the spacer ring 440, to the second end surface of the first outer ring 406. The direction of the load is in the axial direction of the rotating shaft 66. Moreover, an insulating material 444 is interposed between the second end surface of the first bearing 400, and the first end surface of the spacer ring 440.

The spacer ring 440 includes a plurality of individual relay holes 446. Each of the individual relay holes 446 communicates, via each of the individual flow through holes 426, with each of the individual first oil supply holes 424.

The inner ring stopper 460 is inserted into the interior of the first bearing holder 420. The first inner ring 402 of the first bearing 400 is sandwiched between the screw cap 200 and the inner ring stopper 460 in the axial direction of the outer shaft 70. Consequently, the first bearing 400 is positioned and fixed at a predetermined location on the outer circumferential surface of the outer shaft 70.

The left end of the first bearing chamber 410 is separated farther away from the output shaft 964 than the right end of the first bearing chamber 410 is. Hereinafter, in the first bearing chamber 410, the left end, which is separated farther away from the output shaft 964 than the right end is, may be referred to as a “first distal end 412”. Further, the right end, which is in closer proximity to the output shaft 964 than the first distal end 412 is, may be referred to as a “first proximal end 414”.

As shown in FIG. 2, a shaft hole 470 is formed at a diametrical center of a resolver holder 56. An extending distal end of the extending portion 90 is passed through the shaft hole 470. At a first end of the resolver holder 56, the shaft hole 470 is closed by a cap cover 472.

A resolver stator 54 is retained on an inner circumferential surface of the shaft hole 470. The resolver rotor 52 is positioned on an inner circumferential side of the resolver stator 54. A resolver 50 is constituted by the resolver stator 54 and the resolver rotor 52.

An engagement hole 474 is formed in the resolver holder 56. A transmission connector 58 is engaged with the engagement hole 474. The resolver stator 54 and the transmission connector 58 are electrically connected via a signal line 59. The transmission connector 58 is a connector for the purpose of transmitting a signal in relation to a rotation parameter to a non-illustrated receiver.

Next, a description will be given concerning the configuration around the circumference of the second end of the rotor 62. As shown in FIG. 2, FIG. 3, and FIG. 5, the second end of the rotating shaft 66 is retained to be capable of rotating in the main housing 24 via the second bearing 500.

A retaining concave portion 508, which is recessed toward the first end and communicates with the rotor chamber 34, is formed at the second end of the main housing 24. A second bearing chamber 520 is formed by the retaining concave portion 508 of the main housing 24, and a hollow concave portion 512 of the second sub-housing 28 which is a hollow body. The second bearing 500 is accommodated in the second bearing chamber 520.

The left end of the second bearing chamber 520 is separated farther away from the output shaft 964 than the right end of the second bearing chamber 520 is. Hereinafter, in the second bearing chamber 520, the left end, which is separated farther away from the output shaft 964 than the right end is, may be referred to as a “second distal end 522”. Further, the right end, which is in closer to the output shaft 964 than the second distal end 522 is, may be referred to as a “second proximal end 524”.

The second bearing 500 is sandwiched between the outer circumferential surface of the second end of the outer shaft 70, and the inner circumferential surface of a second bearing holder 530. The second bearing holder 530 is connected via bolts or the like to the second end of the main housing 24. Consequently, the second bearing holder 530 is positioned and fixed to the rotating electric machine housing 22.

The second bearing holder 530 is positioned diametrically outward of a second outer ring 506, and covers the second bearing 500 from the outer circumferential surface side of the second outer ring 506. A non-illustrated insulating material is interposed between the outer circumferential surface of the second outer ring 506, and the inner circumferential surface of the second bearing holder 530.

An inner side inner ring stopper 540 and an outer side inner ring stopper 542 are inserted into the interior of the second bearing holder 530. The inner side inner ring stopper 540 is positioned at the second distal end 522, and the outer side inner ring stopper 542 is positioned at the second proximal end 524. A second inner ring 502 of the second bearing 500 is sandwiched between the inner side inner ring stopper 540 and the outer side inner ring stopper 542. Consequently, the second bearing 500 is positioned and fixed at a predetermined location on the outer circumferential surface of the outer shaft 70.

A flow rectifying member 550 is accommodated in the hollow concave portion 512 of the second sub-housing 28. The flow rectifying member 550 is of a substantially truncated conical shape, and decreases in diameter in a tapered shape from a first end toward a second end thereof. The second end of the flow rectifying member 550 is positioned and fixed to the second end of the main housing 24.

A ventilation hole 554 is formed at a center in the diametrical direction of the flow rectifying member 550. The outer circumferential surface of the outer side inner ring stopper 542 faces in the diametrical direction with respect to the inner circumferential surface of the ventilation hole 554.

As shown in FIG. 2, FIG. 3, FIG. 4, and FIG. 5, annular shaped flow through spaces 216 are formed respectively on the screw cap 200, between the groove shaped flow paths 212 of the second shaft portion 70b and the first inner ring 402 of the first bearing 400, between the third shaft portion 70c and the inner ring stopper 460, and between the third shaft portion 70c and the sleeve 220. The rotor internal flow path 210 is formed by these flow through spaces 216.

The rotor internal flow path 210 is a flow path that extends in the axial direction of the rotating shaft 66, and for example, may be an annular shaped space that extends partially in the axial direction. The rotor internal flow path 210 extends from the first end to the second end of each of the permanent magnets 270 in the axial direction of the rotating shaft 66. The rotor internal flow path 210 may be a groove or the like.

The rotor 62 is constituted in the manner described above. Next, with reference to FIG. 2 and FIG. 3, a description will be given concerning the stator 64. The stator 64 constitutes the rotating electric machine 60 together with the aforementioned rotor 62. The stator 64 includes a stator core 300, and the plurality of individual electromagnetic coils 310.

The stator core 300 is a cylindrically shaped member. The stator core 300 is constituted, for example, by laminating a plurality of ring-shaped electromagnetic steel plates in the axial direction. A plurality of individual slots are formed in the stator core 300. Teeth portions are positioned between adjacent ones of the slots.

The plurality of individual electromagnetic coils 310 are a U-phase coil, a V-phase coil, and a W-phase coil. As can be understood from this feature, in the case that the rotating electric machine 60 is a generator, the rotating electric machine 60 is a so-called three-phase electrical power source. Each of the plurality of individual electromagnetic coils 310 is constituted by winding a conductive wire around the teeth portions of the stator core 300.

Among the plurality of individual electromagnetic coils 310, portions thereof that project out in the axial direction from the stator core 300 become end portions of the electromagnetic coils 310. The end portions of the plurality of individual electromagnetic coils 310 constitute a coil end portion 314 shown in FIG. 2.

Concerning each of the plurality of individual electromagnetic coils 310, the other end (a terminal end 316) of the conductive wire that makes up each of the electromagnetic coils 310 is pulled out from the coil end portion 314. The terminal ends 316, by being bundled together and connected, thereby constitute a neutral point 318. The neutral point 318, by being inserted into the interior of a neutral point terminal 320, is fixed to the coil end portion 314.

A brief description will now be given concerning the external configuration of the rotating electric machine housing 22. As shown in FIG. 1, the first casing 40 and the second casing 42 are integrally provided on an outer circumferential surface in the vicinity of a left end of the main housing 24. More specifically, the first casing 40 and the second casing 42 serve as one portion of the main housing 24.

As shown in FIG. 2, a lower contact chamber 44 and an upper terminal chamber 46 are formed in the interior of the first casing 40. The contact chamber 44 and the terminal chamber 46 become spaces that are independent from each other. The contact chamber 44 communicates with the stator chamber 36. In the contact chamber 44, an insertion port 48 is formed that opens at a first end surface of the first casing 40. The insertion port 48 is closed by a lid member 45.

A U-phase terminal 110a, a V-phase terminal 110b, and a W-phase terminal 110c are accommodated in the terminal chamber 46. The U-phase terminal 110a, the V-phase terminal 110b, and the W-phase terminal 110c are electrically connected to the U-phase coil, the V-phase coil, and the W-phase coil of the electromagnetic coils 310, respectively, in the contact chamber 44. In FIG. 2, a state is illustrated in which a terminal portion 112 of the V-phase terminal 110b, and a terminal wire 322 of the V-phase coil are connected via a screw 280.

As shown in FIG. 1, the second casing 42 is adjacent to the first casing 40. A thermistor 120, which serves as a temperature measurement device, is accommodated in the second casing 42. A harness 122 that is connected to the thermistor 120 is drawn out from the second casing 42.

In the rotating electric machine system 20 which is configured in the manner described above, there are provided an air coolant flow path 730 (refer to FIG. 2) that includes a gaseous coolant flow path 700, a first oil coolant flow path 800 (refer to FIG. 2), a lubricating oil flow path 840 (refer to FIG. 3), and a second oil coolant flow path 870 (refer to FIG. 3). Initially, a description will be given concerning the air coolant flow path 730.

As shown in FIG. 2, the air coolant flow path 730 includes an air supply passage 732, the gaseous coolant flow path 700, a first branching passage 734, a first drain passage 736, a second branching passage 738, and a second drain passage 740. An air supply port serving as an inlet to the air supply passage 732 is provided on a side circumferential surface of the first sub-housing 26. The first branching passage 734 and the second branching passage 738 are one portion of the rotor chamber 34. The second drain passage 740 serves in a dual manner as an oil discharge passage and a gaseous coolant discharge passage.

As shown in FIG. 2, the air supply passage 732 is formed in the interior of the first sub-housing 26. The air supply passage 732 extends from the side circumferential surface of the first sub-housing 26 toward the interior of the first sub-housing 26. Moreover, although in FIG. 2, a configuration is illustrated in which one air supply passage 732 is formed, a plurality of individual air supply passages 732 may be formed therein.

As noted previously, the gaseous coolant flow path 700 is a space formed between the second end surface of the first sub-housing 26 and a second wall surface 614 of the partition member 610. The gaseous coolant flow path 700, as it approaches toward the interior of the first sub-housing 26, is inclined in a manner so as to face from the first end toward the second end.

An opening of a first end in the partition wall member 32 is an inlet port for the compressed air AR that has flowed out from the gaseous coolant flow path 700 into the rotor chamber 34. Moreover, an opening of a second end of the partition wall member 32 is an outlet port for the compressed air AR from the rotor chamber 34.

The first branching passage 734 and the second branching passage 738, in the interior of the rotor chamber 34, branch off mutually from each other at a border of the magnet stopper 272. The first branching passage 734 is a flow path that faces from the magnet stopper 272 toward the first bearing 400. The second branching passage 738 is a flow path that passes through a clearance that extends in the axial direction between the magnet stopper 272 and the partition wall member 32, and faces toward the second bearing 500. Hereinafter, in the compressed air AR, one portion thereof that flows through the first branching passage 734 will be referred to as a “first branched air flow AR1”, and a remaining portion thereof that flows through the second branching passage 738 will be referred to as a “second branched air flow AR2”.

As shown in FIG. 2 and FIG. 4, the first branching passage 734 includes a space formed between a first end surface of the magnet stopper 272 and a second end surface of the guide member 560, and a clearance formed between the inner ring stopper 460 and the guide member 560. As can be understood from this feature, the first proximal end 414 of the first bearing chamber 410 is contained within the first branching passage 734.

The first drain passage 736 includes a first guidance passage 742, a hollow portion 464, a second guidance passage 744, and a merging flow path 746. An inlet port into the first guidance passage 742 is formed in the first sub-housing 26 at a location facing toward the flow through holes 426 of the first bearing holder 420. It should be noted that the number of the first drain passage 736 is not particularly limited, but is typically from one to three. An outlet port of the first guidance passage 742 communicates with the hollow portion 464.

The hollow portion 464 is a space surrounded by an annular wall portion 462 of the first sub-housing 26, and further, which is closed by the resolver holder 56. The second guidance passage 744 is formed at the lower part of the first sub-housing 26, and extends downward in a straight line shape. An inlet port of the second guidance passage 744 opens toward the hollow portion 464.

The merging flow path 746 is perpendicular with respect to the second guidance passage 744, and extends in the axial direction. An inlet of the merging flow path 746 opens toward the second guidance passage 744.

The second branching passage 738 is primarily formed between the outer circumferential surfaces of the permanent magnets 270 and the inner circumferential surface of the partition wall member 32. The opening at the second end of the partition wall member 32 is an outlet port by which the compressed air AR flows out from the rotor chamber 34.

The main housing 24 includes in an interior thereof an air distribution passage 702 as shown in FIG. 2. An inlet port into the air distribution passage 702 faces toward an opening of the second end of the partition wall member 32. Therefore, one portion of the second branched air flow AR2 flows into the air distribution passage 702. Hereinafter, the compressed air AR that flows into the air distribution passage 702 will be referred to as a “branched air flow Sb”. The air distribution passage 702 communicates with an internal passage between an inner surface that forms the hollow concave portion 512 of the second sub-housing 28, and an outer surface of the flow rectifying member 550. The outlet port of the internal passage communicates with the second proximal end 524 of the second bearing chamber 520. The outlet port of the internal passage also communicates with the ventilation hole 554. The ventilation hole 554 is an annular shaped space that is formed between the second sub-housing 28 and the outer shaft 70.

The second branching passage 738 further includes the clearance between the outer circumferential surface of the collar 240 and the inner circumferential surface of the partition wall member 32, and the second distal end 522 of the second bearing chamber 520. In the second branched air flow AR2, a remaining portion thereof that did not flow into the air distribution passage 702 flows in between the second bearing holder 530 and the inner side inner ring stopper 540, at the second distal end 522 of the second bearing chamber 520. Moreover, in order to simplify the description, hereinafter, the remaining portion of the second branched air flow AR2 that flows through the second branching passage 738 will be referred to as a “main air flow Ms”.

The second drain passage 740 extends downwardly in the interior of the main housing 24. The merging flow path 746 communicates perpendicularly with the second drain passage 740. Stated otherwise, the merging flow path 746 merges into the second drain passage 740. The second drain passage 740 extends to the outer surface of the rotating electric machine housing 22.

As shown in FIG. 7, the compressed air AR that is discharged from the second drain passage 740 is recovered in a gas-liquid separation device 900. As will be discussed later, the compressed air AR is separated from the cooling oil CO2 and the lubricating oil LO in the gas-liquid separation device 900. The compressed air AR from which the oil has been separated is discharged from the gas-liquid separation device 900 into the atmosphere. The gas-liquid separation device 900 serves as an oil recovery device 901, and further, together with a later-described circulation pump 902, constitutes the oil supplying device 904. In this manner, the gas-liquid separation device 900 serves in a dual manner as both the oil recovery device 901, and one portion of the oil supplying device 904.

A description will be given concerning the first oil coolant flow path 800. The first oil coolant flow path 800 is a flow path in order to circulate and supply the cooling oil Col into the stator chamber 36. The first oil coolant flow path 800 includes a first oil supply passage 802 that is connected to a tank 906, the stator chamber 36, and a stator chamber side drain passage 804 that is connected to the tank 906. The first oil supply passage 802 is disposed in close proximity to the second end of the main housing 24. The stator chamber side drain passage 804 is disposed on a side part of the first casing 40. The first oil supply passage 802 communicates with the stator chamber 36, and the stator chamber 36 communicates with the contact chamber 44 of the first casing 40 (refer to FIG. 2). The contact chamber 44 communicates with the stator chamber side drain passage 804.

A first return pipe 910 in order to resupply the cooling oil CO1 to the first oil supply passage 802 is connected to the tank 906. As shown in FIG. 7, the cooling oil Col that flows through the stator chamber side drain passage 804 may be delivered to the gas-liquid separation device 900, and thereafter, may be delivered from the gas-liquid separation device 900 to the tank 906.

Next, a description will be given concerning the lubricating oil flow path 840. The lubricating oil flow path 840 is a flow path in order to circulate and supply the lubricating oil LO to the first bearing 400 and the second bearing 500. The lubricating oil flow path 840 includes a second oil supply passage 842, a first oil distribution passage 846, a second oil distribution passage 848, the first drain passage 736, a third oil supply passage 843, a third oil distribution passage 852, and the second drain passage 740.

The second oil supply passage 842 is disposed on an upper part of the first sub-housing 26. The second oil supply passage 842, in the interior of the first sub-housing 26, branches into the first oil distribution passage 846 and the second oil distribution passage 848. The first oil distribution passage 846 extends from the diametrical outward direction toward the diametrical inward direction of the first sub-housing 26. The communication holes 452 of the holder spacer 450 are positioned downstream of the first oil distribution passage 846. The first oil supply holes 424 of the first bearing holder 420 are positioned downstream of the communication holes 452.

The second oil distribution passage 848 branches off from the first oil distribution passage 846. The second oil distribution passage 848 is formed in the interior of a first nozzle member 844 (refer to FIG. 3). A discharge portion 850 of the first nozzle member 844 faces toward the first distal end 412 of the first bearing chamber 410.

The first drain passage 736 including the hollow portion 464 is formed at a lower portion of the first sub-housing 26. The lubricating oil LO supplied to the first bearing 400, after having passed through the first drain passage 736, flows out via the second drain passage 740 to the exterior of the rotating electric machine housing 22. The lubricating oil LO discharged from the second drain passage 740 is recovered by the gas-liquid separation device 900.

At the second end of the main housing 24, the third oil distribution passage 852 is bent in a manner so as to face in a diametrically inward direction. The third oil distribution passage 852 is connected to a second oil supply hole 536 that is formed in the second bearing holder 530. The third oil supply passage 843 merges with the third oil distribution passage 852 at a location more upstream than the second oil supply hole 536.

The second drain passage 740 that communicates with the second bearing chamber 520 is formed at a lower portion of the first sub-housing 26. The lubricating oil LO supplied to the second bearing 500 flows out via the second drain passage 740 to the exterior of the rotating electric machine housing 22. The lubricating oil LO discharged from the second drain passage 740 is recovered by the gas-liquid separation device 900.

The second oil coolant flow path 870 is a flow path in order to circulate and supply the cooling oil CO2 into the rotor internal flow path 210. More specifically, the second oil coolant flow path 870 includes a fourth oil supply passage 872 that is connected via a third return pipe 914 to the gas-liquid separation device 900, the rotor internal flow path 210, and the second drain passage 740 that is connected to the tank 906. The fourth oil supply passage 872 is disposed on a lower part of the first sub-housing 26. An oil guidance passage 876 that is formed in a second nozzle member 874 is connected to the fourth oil supply passage 872. A discharge portion 878, which is an outlet port of the oil guidance passage 876, faces toward the first shaft portion 70a.

The screw cap 200 includes the annular shaped flow through space 216 therein. The flow through space 216 communicates with the groove shaped flow paths 212 that are formed on the outer surface of the second shaft portion 70b, and further, are covered by the first inner ring 402 of the first bearing 400. Furthermore, the groove shaped flow paths 212 communicate with the second distal end 522 of the second bearing chamber 520, via the guide flow path 214, the flow through space 216 between the outer shaft 70 and the inner ring stopper 460, the flow through space 216 between the outer shaft 70 and the magnet stopper 272, the flow through space 216 between the outer shaft 70 and the sleeve 220, and the internal space 242 between the outer shaft 70 and the collar 240.

The second bearing chamber 520 communicates with the second drain passage 740. The cooling oil CO2 that has flowed through the second drain passage 740 is discharged to the exterior of the rotating electric machine housing 22 in the same manner as the lubricating oil LO. The cooling oil CO2 that is discharged from the second drain passage 740 is recovered by the gas-liquid separation device 900. The cooling oil CO2 that is discharged from the gas-liquid separation device 900 passes through the tank 906, and then is returned via the third return pipe 914 to the fourth oil supply passage 872.

An oil delivery passage 908 in which the tank 906 and the circulation pump 902 are provided is connected to the gas-liquid separation device 900 shown in FIG. 7. The oil that is stored in the tank 906 is delivered by the circulation pump 902 to the first return pipe 910, a second return pipe 912, and the third return pipe 914 that are connected to the circulation pump 902.

An unillustrated recovery passage is connected to the gas-liquid separation device 900. The compressed air AR, the cooling oil CO1, and the cooling oil CO2 and the lubricating oil LO that are discharged from the second drain passage 740 flow via the recovery passage into the gas-liquid separation device 900. In the foregoing manner, the gas-liquid separation device 900 serves to separate the compressed air AR and the oil. The compressed air AR is discharged to the atmosphere via an exhaust line 920. On the other hand, the oil is temporarily stored in the tank 906. Thereafter, the lubricating oil LO is drawn in from the tank 906 by the circulation pump 902, and is delivered to the first return pipe 910, the second return pipe 912, and the third return pipe 914. By the foregoing process being repeated, the oil inside the tank 906 is circulated and supplied as the lubricating oil LO, the cooling oil CO1, or the cooling oil CO2.

Moreover, it should be noted that it is also possible to make use of both the lubricating oil LO, and the cooling oil CO2 that flows through the rotor internal flow path 210. In this case, for example, the lubricating oil LO which is supplied to the second oil supply passage 842 is distributed to the first nozzle member 844 and the second nozzle member 874.

The rotating electric machine system 20 is basically configured as described above. Next, a description will be given concerning the gas turbine engine 950. Moreover, it should be noted that the configuration of the gas turbine engine 950, for example, is similar to the configuration shown in FIG. 8 of JP 2022-157789 A. Therefore, the description of the gas turbine engine 950 will be kept brief.

The gas turbine engine 950 is equipped with an engine housing 952. The engine housing 952 includes an inner housing 954 and an outer housing 956. The inner housing 954 is connected to the second sub-housing 28 of the rotating electric machine system 20. The outer housing 956 is connected to the inner housing 954.

The inner housing 954 has a plurality of individual leg members 958. In the illustrated example, the number of the leg members 958 is six. However, the number of the leg members 958 is determined in accordance with the coupling strength required between the gas turbine engine 950 and the rotating electric machine system 20. Stated otherwise, the number of the leg members 958 is not limited to being six as in the illustrated example. Air intake spaces 960 are formed between the leg members 958.

The gas turbine engine 950 is equipped with the output shaft 964 that is coupled to the rotating shaft 66. A non-illustrated compressor wheel and a non-illustrated turbine wheel are mounted in a diametrical outward direction of the output shaft 964. The compressor wheel and the turbine wheel are capable of rotating integrally together with the rotating shaft 66 and the output shaft 964.

Next, a description will be given concerning the operations of the combined power system 10.

At first, an alternating current is supplied to the plurality of individual electromagnetic coils 310 (the U-phase coil, the V-phase coil, and the W-phase coil) via the U-phase terminal 110a, the V-phase terminal 110b, and the W-phase terminal 110c. By the alternating current flowing through the electromagnetic coils 310, an alternating magnetic field is generated in the stator 64. Therefore, an attractive force and a repulsive force act alternately between the electromagnetic coils 310, and the permanent magnets 270 of the rotor 62. As a result, the rotating shaft 66 begins to rotate. Alternatively, the rotating shaft 66 may be rotated by a well-known type of starter (not shown).

When the rotating shaft 66 begins to rotate, the output shaft 964 also starts rotating integrally together with the rotating shaft 66. Along therewith, the compressor wheel and the turbine wheel, which are supported by the output shaft 964, rotate integrally together with the output shaft 964.

After the gas turbine engine 950 has been started in the manner described above, the output shaft 964 rotates accompanying the driving of the gas turbine engine 950. Accordingly, even if the supply of the electric current to the electromagnetic coils 310 is stopped, the rotating shaft 66 rotates integrally together with the output shaft 964.

Since the rotating shaft 66 retains the permanent magnets 270, the alternating current is generated in the electromagnetic coils 310 that surround the permanent magnets 270. Via the U-phase terminal 110a, the V-phase terminal 110b, and the W-phase terminal 110c, the alternating current is delivered to a non-illustrated current converter. By the current converter, the alternating current is converted into a direct current. When a non-illustrated control circuit has determined that the output of the external load electrically connected to the battery has decreased, the current converter supplies the direct current to the battery. Consequently, charging is carried out on the battery.

By the output shaft 964 undergoing rotation, atmospheric air is drawn into the engine housing 952 via the air intake spaces 960 provided between the leg members 958 of the inner housing 954. In this instance, the second sub-housing 28 of the rotating electric machine system 20 exhibits a mountain shape (chevron shape) in a manner so as to decrease in diameter as it proceeds from the main housing 24 toward the engine housing 952. Therefore, the drawn in atmospheric air is rectified by the second sub-housing 28, and flows in a manner so as to be directed toward the engine housing 952. Since the second end of the second sub-housing 28 is inserted into the opening at the first end of the engine housing 952, the atmospheric air is efficiently guided into the engine housing 952.

The atmospheric air that is drawn into the engine housing 952 is compressed by the compressor wheel. In accordance therewith, the compressed air AR is generated. One portion of this compressed air AR is extracted, and is supplied to an air supply port provided on the outer circumferential surface of the first sub-housing 26. Moreover, the compressed air AR, which is obtained by compressing the atmosphere by means of the compressor, may be supplied to the air supply port. Alternatively, a compressed gas may be supplied to the air supply port from an oxygen cylinder or a nitrogen cylinder.

The compressed air AR that has flowed via the air supply port into the air supply passage 732 flows into the gaseous coolant flow path 700 that is formed between the second end surface of the first sub-housing 26, and the second wall surface 614 of the partition member 610. The compressed air AR moves through the gaseous coolant flow path 700 toward the rotor chamber 34 in the interior of the rotating electric machine housing 22.

The compressed air AR flows, via the opening at the first end of the partition wall member 32, from the gaseous coolant flow path 700 into the rotor chamber 34. In the rotor chamber 34, the compressed air AR is divided into the first branched air flow AR1 and the second branched air flow AR2 with the magnet stopper 272 serving as a boundary therebetween. The first branched air flow AR1 reaches the first proximal end 414 of the first bearing chamber 410 along the first branching passage 734, and forms an air curtain at the first proximal end 414. Due to the air curtain, the first bearing 400 is cooled.

As shown in FIG. 4, an excess amount of the first branched air flow AR1 passes through the relay holes 446 of the spacer ring 440, and the flow through holes 426 of the first bearing holder 420, and flows into the first drain passage 736. As noted previously, the first drain passage 736 includes the first guidance passage 742, the hollow portion 464, the second guidance passage 744, and the merging flow path 746. The first branched air flow AR1 that has passed through the flow through holes 426 initially flows into the first guidance passage 742 that is formed in the first sub-housing 26. Since the first guidance passage 742 communicates with the second guidance passage 744 via the hollow portion 464, and the second guidance passage 744 communicates with the merging flow path 746, the first branched air flow AR1 flows sequentially through the hollow portion 464, the second guidance passage 744, and the merging flow path 746. Thereafter, the first branched air flow AR1 flows from the merging flow path 746 into the second drain passage 740.

As shown in FIG. 5, the second branched air flow AR2 flows inside the rotor chamber 34 which is one portion of the second branching passage 738. Inside the rotor chamber 34, the second branched air flow AR2 primarily flows between the outer circumferential surface of the permanent magnets 270 and the inner circumferential surface of the partition wall member 32. At this time, the second branched air flow AR2 comes into contact with the permanent magnets 270. Due to such contact, the rotor 62 is cooled. The second branched air flow AR2 that has cooled the rotor 62, at the opening of the second end of the partition wall member 32, is separated into the main air flow Ms that flows through the second branching passage 738, and the branched air flow Sb that flows through the air distribution passage 702.

The main air flow Ms reaches the second distal end 522 of the second bearing chamber 520. On the other hand, the branched air flow Sb passes between the inner surface forming the hollow concave portion 512 of the second sub-housing 28, and the outer surface of the flow rectifying member 550, and reaches the second proximal end 524 of the second bearing chamber 520. Moreover, the remainder of the branched air flow Sb is discharged externally of the rotating electric machine housing 22 via the ventilation hole 554 that is formed between the second sub-housing 28 and the outer shaft 70. In this manner, by the excess amount of the compressed air AR being discharged externally of the rotating electric machine housing 22, the pressure of the compressed air AR that flows through the interior of the rotating electric machine housing 22 is adjusted to be substantially constant.

As can be understood from the foregoing, an air curtain that surrounds the second bearing 500 is formed in the second bearing chamber 520. Due to the air curtain, the second bearing 500 is cooled.

The second branched air flow AR2 that is supplied to the second bearing chamber 520 is guided by an inner surface 551 of the flow rectifying member 550, and flows toward the second drain passage 740. In the second drain passage 740, the first branched air flow AR1 and the second branched air flow AR2 merge together. In this instance, the lubricating oil LO is supplied respectively to the first bearing 400 and the second bearing 500. Therefore, the first branched air flow AR1 that has passed through the first bearing chamber 410 is a gas-liquid mixture. Similarly, the second branched air flow AR2 that has passed through the second bearing chamber 520 is a gas-liquid mixture. The first branched air flow AR1 and the second branched air flow AR2 that have passed through the merging flow path 746 are led from the rotating electric machine housing 22 to the gas-liquid separation device 900.

In the gas-liquid separation device 900, the compressed air AR and the oil (for example, the lubricating oil LO) are separated from each other. The compressed air AR from which the oil has been separated is discharged from the gas-liquid separation device 900 into the atmosphere.

Simultaneously with the compressed air AR flowing through the rotating electric machine housing 22 in the manner described above, the cooling oil CO1, the cooling oil CO2, and the lubricating oil LO also flow inside the rotating electric machine housing 22. A description will be given concerning the flow through passages of the cooling oil CO1, the cooling oil CO2, and the lubricating oil LO.

In the first oil coolant flow path 800, the cooling oil Col is supplied from the tank 906 to the first oil supply passage 802. Since the first oil supply passage 802 communicates with the stator chamber 36, the cooling oil CO1 moves toward the stator chamber side drain passage 804 while filling the stator chamber 36. In this manner, the stator 64 inside the stator chamber 36 becomes placed in a state of being immersed in the cooling oil CO1. In accordance with this feature, the stator 64 is cooled.

In a process in which the cooling oil CO1 inside the stator chamber 36 flows toward the stator chamber side drain passage 804, the neutral point 318 and the neutral point terminal 320 are cooled by the cooling oil CO1. Further, the conduction of heat from the coil end portion 314 to the neutral point terminal 320 can be reduced.

The cooling oil CO1 inside the stator chamber 36 flows toward the first casing 40 along the first wall surface 612 of the partition member 610. As can be understood from this feature, the flow through direction of the cooling oil Col that flows along the first wall surface 612 of the partition member 610, and the flow through direction of the compressed air AR that flows along the second wall surface 614 of the partition member 610 are mutually opposite directions.

The cooling oil Col that has flowed through the stator chamber 36 flows from the first end of the stator chamber 36 and into the contact chamber 44 of the first casing 40. The cooling oil CO1 inside the contact chamber 44 comes into contact with the terminal portions 112, the terminal wires 322, and the screws 280. Consequently, the electrical contact between the U-phase terminal 110a and the U-phase coil is cooled. For the same reason, the electrical contact between the V-phase terminal 110b and the V-phase coil is also cooled. The electrical contact between the W-phase terminal 110c and the W-phase coil is also cooled.

The cooling oil CO1 inside the contact chamber 44 passes through the stator chamber side drain passage 804, and is recovered in the tank 906. Thereafter, the cooling oil CO1 is resupplied from the tank 906 to the first oil supply passage 802 via the first return pipe 910. Moreover, the cooling oil Col that had flowed through the stator chamber side drain passage 804 may be delivered to the gas-liquid separation device 900, and thereafter, delivered from the gas-liquid separation device 900 to the tank 906.

In the lubricating oil flow path 840, the lubricating oil LO is supplied from the tank 906 to the second oil supply passage 842. One portion of the lubricating oil LO is supplied to the first outer ring 406 of the first bearing 400 via the first oil distribution passage 846, the communication holes 452 of the holder spacer 450, and the first oil supply holes 424 of the spacer ring 440. Another portion of the lubricating oil LO flows from the first oil distribution passage 846 into the second oil distribution passage 848 that is formed in the first nozzle member 844, and furthermore, is discharged from the discharge portion 850 provided in the first nozzle member 844 into the first distal end 412 of the first bearing chamber 410. Accordingly, the direction in which the lubricating oil LO is supplied to the first bearing chamber 410 is a first direction from the first bearing chamber 410 toward the permanent magnets 270. In the foregoing manner, the lubricating oil LO that is supplied to the first bearing 400 cools and lubricates the first bearing 400. Thereafter, the lubricating oil LO passes via the hollow portion 464 of the first sub-housing 26 and the first drain passage 736, and is recovered in the gas-liquid separation device 900.

Still another portion of the lubricating oil LO flows from the second oil supply passage 842 into the third oil distribution passage 852, and is supplied, via the second oil supply hole 536 that is formed in the second bearing holder 530, to the second outer ring 506 of the second bearing 500. The lubricating oil LO is also supplied to the second bearing 500 from a discharge portion 556 provided in the main housing 24. Such a lubricating oil LO cools and lubricates the second bearing 500. Thereafter, via the second drain passage 740 that communicates with the second bearing chamber 520, the lubricating oil LO is recovered in the gas-liquid separation device 900.

As noted previously, the first branched air flow AR1 supplied to the first proximal end 414 of the first bearing chamber 410 forms an air curtain. It is difficult for the lubricating oil LO that is supplied to the first bearing 400 to pass through the air curtain and infiltrate into the rotor chamber 34. In the second bearing chamber 520, the main air flow Ms that is supplied to the second distal end 522, and the branched air flow Sb that is supplied to the second proximal end 524 form an air curtain. It is difficult for the lubricating oil LO that is supplied to the second bearing 500 to pass through the air curtain and infiltrate into the rotor chamber 34. Therefore, the lubricating oil LO is prevented from infiltrating into the rotor chamber 34. Consequently, it is possible to avoid a situation in which the permanent magnets 270 become contaminated by the lubricating oil LO.

Further, it is difficult for the lubricating oil LO to infiltrate from the second bearing chamber 520 into the hollow concave portion 512 of the second sub-housing 28. Accordingly, it is also possible to avoid a situation in which the flow rectifying member 550 becomes contaminated by the lubricating oil LO.

The lubricating oil LO contains the compressed air AR that has formed the air curtain. The gas-liquid separation device 900 separates the compressed air AR from the lubricating oil LO. The lubricating oil LO from which the compressed air AR has been separated is temporarily stored in the tank 906, and thereafter, is resupplied to the second oil supply passage 842 from the second return pipe 912.

A description will now be given concerning the cooling oil CO2 that flows through the rotor internal flow path 210.

In the second oil coolant flow path 870, the cooling oil CO2 is supplied from the tank 906 to the fourth oil supply passage 872, and flows through the oil guidance passage 876 that is formed in the second nozzle member 874. The cooling oil CO2 is discharged from the discharge portion 878 provided in the second nozzle member 874, and toward the first shaft portion 70a of the outer shaft 70. The cooling oil CO2 flows, in the axial direction of the rotating shaft 66, through the rotor internal flow path 210 from the first end toward the second end. Specifically, the cooling oil CO2 passes through the flow through space 216 between the screw cap 200 and the first shaft portion 70a, the groove shaped flow path 212 that is covered by the first inner ring 402 of the first bearing 400, the guide flow path 214, the flow through space 216 between the outer shaft 70 and the inner ring stopper 460, the flow through space 216 between the outer shaft 70 and the magnet stopper 272, and the flow through space 216 between the outer shaft 70 and the sleeve 220.

The cooling oil CO2 that has reached the flow through space 216 between the outer shaft 70 and the sleeve 220 flows, at the second end of the sleeve 220, into the communication flow path 232 via the inlet port 234. The communication flow path 232 is inclined in a manner so that, as it proceeds from the upstream side to the downstream side in the flow through direction of the cooling oil CO2, faces from the inner side toward the outer side in the diametrical direction of the rotating shaft 66. A centrifugal force acts on the rotating shaft 66 that is undergoing rotation. Due to the centrifugal force, the cooling oil CO2 easily moves along the communication flow path 232 toward the first inner chamber 242a.

The cooling oil CO2 that has flowed through the communication flow path 232 flows into the first inner chamber 242a which is one portion of the internal space 242. The inner circumferential surface 256a of the collar 240 that forms the first inner chamber 242a abuts against the abutment surface 230 of the first annular shaped convex portion 226. The outlet port 236 for the cooling oil CO2 to the communication flow path 232 is positioned more inwardly in the diametrical direction of the rotating shaft 66 than the abutment surface 230. More specifically, the abutment surface 230 is not provided with the outlet port 236 (such as a notch or a hole or the like). Accordingly, the entirety of the abutment surface 230 abuts against the inner circumferential surface 256a of the first inner chamber 242a.

Since the rotor 62 is undergoing rotation, a centrifugal force acts on the sleeve 220 and the collar 240. Due to the centrifugal force, the inserted portion 224 and the tubular shaped portion 244 are deformed in a manner so as to bulge slightly outward in the diametrical direction of the rotating shaft 66. As noted previously, the abutment surface 230 does not include the outlet port 236. Based on this feature, even in the case that the rotor 62 rotates at a high speed, the surface pressure of the abutment surface 230 with respect to the inner circumferential surface 256a of the first inner chamber 242a is maintained. Consequently, the sealing property between the abutment surface 230 and the inner circumferential surface 256a is maintained. Accordingly, the cooling oil CO2 is prevented from leaking out from between the abutment surface 230 and the inner circumferential surface 256a.

As can be appreciated from the reasons described above, it is easy to cause the cooling oil CO2 to be moved from the first inner chamber 242a through the discharge flow path 254 and to the second inner chamber 242b. Stated otherwise, the cooling oil CO2 is prevented from being discharged from any place other than the opening of the second end of the second inner chamber 242b. The direction from the first inner chamber 242a to the second inner chamber 242b is a direction to separate away from the sleeve 220 and the permanent magnets 270. More specifically, according to the above-described configuration, it is easy to cause the cooling oil CO2 to move in a direction away from the permanent magnets 270. Accordingly, even if the rotor 62 is of an SPM type, the permanent magnets 270 are unlikely to become contaminated by the cooling oil CO2.

The cooling oil CO2 is discharged from the opening at the second end of the collar 240 to the exterior of the second inner chamber 242b. The cooling oil CO2, which has flowed through the rotor internal flow path 210 and the internal space 242 in the manner described above, reaches the second distal end 522 of the second bearing chamber 520.

At the second distal end 522, the cooling oil CO2 mixes together with the compressed air AR. The cooling oil CO2 in which the compressed air AR is contained merges with the lubricating oil LO in the second drain passage 740. Thereafter, in the same manner as the lubricating oil LO, the cooling oil CO2 is recovered via the second drain passage 740 in the gas-liquid separation device 900. The cooling oil CO2, from which the compressed air AR has been separated in the gas-liquid separation device 900, is temporarily stored in the tank 906, and thereafter, is returned via the third return pipe 914 to the fourth oil supply passage 872.

In the foregoing manner, according to the present embodiment, the same oil is used in a dual manner as the lubricating oil LO (the lubricant), and the cooling oil CO1 and the cooling oil CO2 (both of which are a liquid coolant). Therefore, it is possible to combine a circulation and supply flow path for the lubricant, and a circulation and supply flow path for the liquid coolant. Accordingly, it is possible to simplify the configuration of the circulation and supply flow path for the lubricant, and the circulation and supply flow path for the liquid coolant. However, the lubricant and the liquid coolant may be different liquids.

The advantageous effects of the present embodiment can be summarized in the following manner.

The sleeve 220 includes the inserted portion 224 at one end part (the second end) in the axial direction of the sleeve 220. The inserted portion 224 is inserted into the internal space 242 of the collar 240, and thereby separates the rotor internal flow path 210 from the internal space 242. The sleeve 220 further includes the communication flow path 232 that is formed in the inserted portion 224, and which places the rotor internal flow path 210 and the internal space 242 in communication. The entirety or a portion of the outer circumferential surface of the inserted portion 224 serves as the abutment surface 230 against which the inner circumferential surface 256a of the first inner chamber 242a of the collar 240 abuts.

The sleeve 220 further has the inlet port 234 in order for the cooling oil CO2, which is a liquid coolant, to flow from the rotor internal flow path 210 into the communication flow path 232, and the outlet port 236 in order for the cooling oil CO2 to flow out from the communication flow path 232 into the internal space 242 (the first inner chamber 242a). In the diametrical direction of the rotating shaft 66, the outlet port 236 is positioned more inwardly than the abutment surface 230.

In accordance with such a configuration, it is unnecessary to form the outlet port 236 in the abutment surface 230. Accordingly, it is unnecessary to cut out and remove a portion of the abutment surface 230 in the axial direction in order to form the outlet port 236 in the abutment surface 230. Accordingly, the entirety of the abutment surface 230 abuts against the inner circumferential surface 256a of the first inner chamber 242a of the collar 240.

By the rotor 62 undergoing rotation, a centrifugal force acts on the sleeve 220 and the collar 240. Due to the centrifugal force, the inserted portion 224 and the tubular shaped portion 244 are deformed in a manner so as to bulge slightly outward in the diametrical direction of the rotating shaft 66. Since the outlet port 236 is not provided on the abutment surface 230, at the time when the rotor 62 is rotated, the surface pressure of the abutment surface 230 with respect to the inner circumferential surface 256a of the first inner chamber 242a is maintained. Consequently, the sealing property between the abutment surface 230 and the inner circumferential surface 256a is maintained. Accordingly, the cooling oil CO2 is prevented from leaking out from between the abutment surface 230 and the inner circumferential surface 256a. As a result, the cooling oil CO2 is prevented from being discharged from any place other than the opening of the second end of the second inner chamber 242b.

The communication flow path 232, as it approaches the internal space 242 from the rotor internal flow path 210, is inclined in a manner so as to face from the inner side to the outer side in the diametrical direction of the rotating shaft 66. The direction from the rotor internal flow path 210 toward the internal space 242 is a direction from upstream to downstream in the flow through direction of the cooling oil CO2.

At the time when the rotating shaft 66 rotates, a centrifugal force acts on the rotating shaft 66. Due to the centrifugal force, the cooling oil CO2 easily moves along the communication flow path 232 toward the internal space 242 (the first inner chamber 242a). More specifically, in accordance with such a configuration, the flowing of the cooling oil CO2 within the communication flow path 232 is assisted.

The collar 240 includes the partition wall 246 that divides the internal space 242 into the first inner chamber 242a and the second inner chamber 242b. The insertion hole 248 and the discharge flow path 254 are formed in the partition wall 246. The discharge flow path 254 places the first inner chamber 242a and the second inner chamber 242b in communication. The inserted portion 224 is inserted into the first inner chamber 242a, and the liquid coolant that is supplied to the rotor internal flow path 210 passes from the first inner chamber 242a through the discharge flow path 254, and is discharged to the exterior of the collar 240 from the second inner chamber 242b.

By the rotating shaft 66 being inserted through the insertion hole 248, the collar 240 can be easily retained on the rotating shaft 66. Further, the liquid coolant CO2 that has flowed through the rotor internal flow path 210 can be quickly discharged, via the communication flow path 232, the internal space 242, and the discharge flow path 254, in a direction away from the abutment surface 230.

The inserted portion 224 includes the first annular shaped convex portion 226 that is projected out in an annular shape in the axial direction from the second end of the main body portion 225 of the sleeve 220, and the second annular shaped convex portion 228 that is projected out in an annular shape in an axial direction from the second end of the first annular shaped convex portion 226. The outer diameter of the second annular shaped convex portion 228 is smaller than the outer diameter of the first annular shaped convex portion 226. Stated otherwise, the second annular shaped convex portion 228 is smaller in diameter than the first annular shaped convex portion 226. The outer circumferential surface of the first annular shaped convex portion 226 includes the abutment surface 230, and the second annular shaped convex portion 228 includes the outlet port 236.

In the inserted portion 224, the distance (the outer diameter) from the center in the diametrical direction of the rotating shaft 66 to the abutment surface 230 can be made smaller in comparison with a case in which the first annular shaped convex portion 226 does not exist. Therefore, the inner diameter of the collar 240 is capable of being made smaller. Consequently, the collar 240 can be made thinner and lighter in weight.

The liquid coolant supplying device is the oil supplying device 904 that supplies the cooling oil CO1 and the cooling oil CO2 as liquid coolants. The rotating electric machine housing 22 includes the lubricating oil flow path 840 for the purpose of supplying the lubricating oil LO from the oil supplying device 904 to the first bearing 400 and the second bearing 500 that support the rotating shaft 66.

One portion of the lubricating oil LO for the purpose of lubricating the first bearing 400 and the second bearing 500 can be supplied to the rotating electric machine housing 22 from the oil supplying device 904 via a system that is separate from the lubricating oil LO, and can be used as a liquid coolant (the cooling oil CO1 and the cooling oil CO2). Accordingly, one individual oil supplying device 904 can be used as a device that serves both as a supplying device for supplying the lubricating oil LO, and as a supplying device for supplying the cooling oil CO1 and the cooling oil CO2. Therefore, it is possible to reduce the cost of capital investment. In addition, the configuration of the rotating electric machine system 20 can be simplified.

The rotating electric machine housing 22 includes the oil discharge passage (the second drain passage 740) that discharges to the oil supplying device 904 the cooling oil CO2 that has passed through the rotor internal flow path 210, and the lubricating oil LO that has flowed through the lubricating oil flow path 840. The oil supplying device 904 resupplies the oil that has been discharged from the oil discharge passage to the rotor internal flow path 210 and the lubricating oil flow path 840.

In accordance with such a configuration, the lubricating oil LO supplied to the first bearing 400 and the second bearing 500, and the cooling oil CO2 that has cooled the rotor 62 are discharged from the rotating electric machine housing 22, while on the other hand, a new lubricating oil LO can be supplied to the first bearing 400 and the second bearing 500, and further, a new cooling oil CO2 can be supplied to the rotor 62. Accordingly, it is possible to continuously lubricate the first bearing 400 and the second bearing 500, and further, it is possible to continuously cool the rotor 62. In addition, since the oil is circulated and supplied, the cost is lower than in a case in which the new oil is continuously supplied.

The rotating electric machine system 20 is equipped with the gaseous coolant supplying device that supplies the gaseous coolant to the first bearing 400 and the second bearing 500. In one aspect, the gaseous coolant supplying device is the gas turbine engine 950 which, together with the rotating electric machine system 20, constitutes the combined power system 10. In another aspect, the gaseous coolant supplying device is a compressor that compresses the atmospheric air. In these cases, the gaseous coolant is the compressed air AR. In still another aspect, the gaseous coolant supplying device includes a container in which a compressed gas is contained.

The rotating electric machine housing 22 includes the gaseous coolant flow path 700 through which the gaseous coolant flows, and the gaseous coolant discharge passage (the second drain passage 740) for the purpose of discharging the gaseous coolant to the exterior of the rotating electric machine housing 22. The oil supplying device 904 recovers the gaseous coolant that has flowed through the gaseous coolant discharge passage and the oil (the lubricating oil LO and the cooling oil CO2) that has flowed through the oil discharge passage (the second drain passage 740), and further, resupplies the oil that has been recovered to the rotor internal flow path 210 and the lubricating oil flow path 840.

Since the oil supplying device 904 recovers the gaseous coolant and the lubricating oil together, it is unnecessary for the gaseous coolant and the lubricating oil to be recovered separately. Accordingly, it is unnecessary to include in the rotating electric machine system 20 a gaseous coolant recovery device that is separate from the oil supplying device 904. Therefore, a situation is avoided in which the configuration of the rotating electric machine system 20 becomes complex.

The oil supplying device 904 includes the gas-liquid separation device 900 that separates the gaseous coolant and the oil.

Since the gas-liquid separation device 900 separates the gaseous coolant and the oil, even though the gaseous coolant and the oil are recovered together, it is possible to resupply only the oil to the rotor internal flow path 210 and the lubricating oil flow path 840. More specifically, according to the present configuration, it is easy to circulate and supply the lubricating oil LO to the first bearing 400 and the second bearing 500.

In relation to the above-described embodiment, the following supplementary notes are further disclosed.

### Supplementary Note 1

The rotating electric machine system (20) is characterized by a rotating electric machine system equipped with the rotating electric machine (60) including the rotor (62) and the stator (64), and the housing (22) in which the stator is accommodated.

The rotor includes the rotating shaft (66), the sleeve (220) configured to cover the rotating shaft from the outer circumferential side, the permanent magnets (270) configured to be retained in the sleeve, the collar (240) configured to be disposed on the outer circumferential side relative to the sleeve and the rotating shaft, the rotor internal flow path (210) configured to include the annular shaped space formed between the outer circumferential surface of the rotating shaft and the inner circumferential surface of the sleeve, and configured to extend in the axial direction of the rotating shaft, and the internal space (242) formed between the outer circumferential surface of the rotating shaft and the inner circumferential surface (256) of the collar.

The rotating electric machine system includes the liquid coolant supplying device (904) configured to supply the liquid coolant (CO2) to the rotor internal flow path. The sleeve includes the inserted portion (224) that is the axial end portion of the sleeve and is inserted into the internal space to separate the internal space from the rotor internal flow path, and the communication flow path (232) that is formed in the inserted portion and is configured to place the internal space and the rotor internal flow path in communication. The outer circumferential surface of the inserted portion includes the abutment surface (230) against which the inner circumferential surface of the collar abuts.

In the above-described configuration, the outlet port (230) through which the liquid coolant flows out from the communication flow path into the internal space is located more inwardly in the diametrical direction of the rotating shaft than the abutment surface.

In accordance with such a configuration, it is unnecessary to form an inlet port and an outlet port by cutting out a portion of the abutment surface of the sleeve. Accordingly, the liquid coolant is prevented from leaking out from between the abutment surface of the sleeve and the inner circumferential surface of the collar.

### Supplementary Note 2

In the rotating electric machine system according to Supplementary Note 1, the communication flow path may be inclined in a manner so as to face outwardly from inwardly in the diametrical direction approaching in close proximity to the internal space from the rotor internal flow path.

When the rotating shaft rotates, a centrifugal force acts on the liquid coolant. Therefore, in the case that the communication flow path is inclined in the manner described above, the liquid coolant can easily move through the communication flow path from the rotor internal flow path toward the internal space.

### Supplementary Note 3

In the rotating electric machine system according to Supplementary Note 1 or 2, the collar may include the partition wall (246) configured to divide the internal space into the first inner chamber (242a) and the second inner chamber (242b), the insertion hole (248) formed in the partition wall and through which the rotating shaft is inserted, and the discharge flow path (254) formed in the partition wall and that places the first inner chamber and the second inner chamber in communication, and the inserted portion may be inserted into the first inner chamber, and the liquid coolant that is supplied to the rotor internal flow path may pass from the first inner chamber via the discharge flow path, and may be discharged to the exterior of the collar from the second inner chamber.

In accordance with such a configuration, the liquid coolant that is supplied to the rotor internal flow path can be quickly discharged, via the communication flow path, the internal space, and the discharge flow path, in a direction away from the abutment surface.

### Supplementary Note 4

The rotating electric machine system according to any one of Supplementary Notes 1 to 3, wherein the inserted portion may include the first annular shaped convex portion (226) configured to project out in an annular shape in the axial direction of the sleeve, and the second annular shaped convex portion (228) configured to be connected to the first annular shaped convex portion, to project out in an annular shape in the axial direction of the sleeve, and further, to be smaller in diameter than the first annular shaped convex portion, and the outer circumferential surface of the first annular shaped convex portion may include the abutment surface, and the second annular shaped convex portion may include the outlet port.

In the inserted portion, the distance (the outer diameter) from the center of the rotating shaft to the abutment surface can be made smaller in comparison with a case in which the first annular shaped convex portion does not exist. In accordance with this feature, the inner diameter of the collar is capable of being made smaller. Therefore, the collar can be made thinner and lighter in weight.

### Supplementary Note 5

The rotating electric machine system according to any one of Supplementary Notes 1 to 4, wherein the liquid coolant supplying device may be the oil supplying device (904) configured to supply the oil as the liquid coolant, and the housing may include the lubricating oil flow path (840) through which the oil as the lubricant (LO) is supplied to the bearing (400 and 500) that supports the rotating shaft.

In this case, one portion of the lubricating oil for the purpose of lubricating the bearings can be used as the liquid coolant. Accordingly, one individual device is capable of being used both as the oil supplying device and the liquid coolant supplying device. Therefore, it is possible to reduce the cost of capital investment. In addition, the configuration of the rotating electric machine system can be simplified.

### Supplementary Note 6

In the rotating electric machine system according to Supplementary Note 5, the housing may include the oil discharge passage (740) through which the oil that has flowed through the rotor internal flow path and the lubricating oil flow path is discharged to the oil supplying device, and the oil supplying device may resupply the oil that has been discharged from the oil discharge passage to the rotor internal flow path and the lubricating oil flow path.

In accordance with such a configuration, the oil (the lubricating oil) that is supplied to the bearing, and the oil (the cooling oil) that has cooled the rotor can be discharged from the housing, while on the other hand, new oil can be supplied to the bearing and rotor. Accordingly, it is possible to continuously lubricate and cool the bearing, and it is also possible to continuously cool the rotor. In addition, since the oil is circulated and supplied, the cost is lower than in a case in which the new oil is continuously supplied.

### Supplementary Note 7

In the rotating electric machine system according to Supplementary Note 6, there may further be provided the gaseous coolant supply device (950) configured to supply the gaseous coolant (AR) to the bearing, wherein the housing may include the gaseous coolant flow path (700) through which the gaseous coolant flows, and the gaseous coolant discharge passage (740) through which the gaseous coolant is discharged to the exterior of the housing, and the oil supplying device may recover the gaseous coolant that has flowed through the gaseous coolant discharge passage and the oil that has flowed through the oil discharge passage, and may resupply the oil to the lubricating oil flow path.

Since the oil supplying device recovers the gaseous coolant and the lubricating oil together, it is unnecessary for the gaseous coolant and the lubricating oil to be recovered separately. Accordingly, there is no particular need to provide a gaseous coolant recovery device in the rotating electric machine system. Therefore, a situation is avoided in which the configuration of the rotating electric machine system becomes complex.

### Supplementary Note 8

In the rotating electric machine system according to Supplementary Note 7, the oil supplying device may include the gas-liquid separation device (900) configured to separate the gaseous coolant and the lubricating oil.

Since the gas-liquid separation device separates the gaseous coolant and the oil, even though the gaseous coolant and the oil are recovered together, only the oil is capable of being resupplied to the oil supply passage. More specifically, in accordance with such a configuration, it is easy to circulate and supply the lubricating oil to the bearings.

Moreover, it should be noted that the present invention is not limited to the disclosure described above, but various configurations may be adopted therein without departing from the essence and gist of the present invention.

1. A rotating electric machine system comprising a rotating electric machine including a rotor and a stator, and a housing in which the stator is accommodated, wherein:
the rotor comprises a rotating shaft, a sleeve configured to cover the rotating shaft from an outer circumferential side, permanent magnets configured to be retained in the sleeve, a collar configured to be disposed on the outer circumferential side relative to the sleeve and the rotating shaft, a rotor internal flow path configured to include an annular shaped space formed between an outer circumferential surface of the rotating shaft and an inner circumferential surface of the sleeve, and configured to extend in an axial direction of the rotating shaft, and an internal space formed between the outer circumferential surface of the rotating shaft and an inner circumferential surface of the collar;
the rotating electric machine system comprises a liquid coolant supplying device configured to supply a liquid coolant to the rotor internal flow path;
the sleeve comprises an inserted portion that is an axial end portion of the sleeve and is inserted into the internal space to separate the internal space from the rotor internal flow path, and a communication flow path that is formed in the inserted portion and is configured to place the internal space and the rotor internal flow path in communication;
an outer circumferential surface of the inserted portion comprises an abutment surface against which the inner circumferential surface of the collar abuts; and
an outlet port through which the liquid coolant flows out from the communication flow path into the internal space is located more inwardly in a diametrical direction of the rotating shaft than the abutment surface.

2. The rotating electric machine system according to claim 1, wherein the communication flow path is inclined in a manner so as to face outwardly from inwardly in the diametrical direction approaching in close proximity to the internal space from the rotor internal flow path.

3. The rotating electric machine system according to claim 1, wherein:
the collar comprises a partition wall configured to divide the internal space into a first inner chamber and a second inner chamber, an insertion hole formed in the partition wall and through which the rotating shaft is inserted, and a discharge flow path formed in the partition wall and that places the first inner chamber and the second inner chamber in communication; and
the inserted portion is inserted into the first inner chamber, and the liquid coolant that is supplied to the rotor internal flow path passes from the first inner chamber via the discharge flow path, and is discharged to an exterior of the collar from the second inner chamber.

4. The rotating electric machine system according to claim 1, wherein:
the inserted portion comprises a first annular shaped convex portion configured to project out in an annular shape in the axial direction of the sleeve, and a second annular shaped convex portion configured to be connected to the first annular shaped convex portion, to project out in an annular shape in the axial direction of the sleeve, and further, to be smaller in diameter than the first annular shaped convex portion; and
an outer circumferential surface of the first annular shaped convex portion includes the abutment surface, and the second annular shaped convex portion includes the outlet port.

5. The rotating electric machine system according to claim 1, wherein:
the liquid coolant supplying device is an oil supplying device configured to supply oil as the liquid coolant; and
the housing comprises a lubricating oil flow path through which the oil as a lubricant is supplied to a bearing that supports the rotating shaft.

6. The rotating electric machine system according to claim 5, wherein the housing comprises an oil discharge passage through which the oil that has flowed through the rotor internal flow path and the lubricating oil flow path is discharged to the oil supplying device, and the oil supplying device resupplies the oil that has been discharged from the oil discharge passage to the rotor internal flow path and the lubricating oil flow path.

7. The rotating electric machine system according to claim 6, further comprising a gaseous coolant supply device configured to supply a gaseous coolant to the bearing,
wherein the housing comprises a gaseous coolant flow path through which the gaseous coolant flows, and a gaseous coolant discharge passage through which the gaseous coolant is discharged to an exterior of the housing, and
the oil supplying device recovers the gaseous coolant that has flowed through the gaseous coolant discharge passage and the oil that has flowed through the oil discharge passage, and resupplies the oil to the lubricating oil flow path.

8. The rotating electric machine system according to claim 7, wherein the oil supplying device includes a gas-liquid separation device configured to separate the gaseous coolant and the lubricating oil.
